(19) United States
(12) Patent Application Publication
(10) Pub. No.: US 2004/0002567 A1
(43) Pub. Date: Jan. 1, 2004

(54) Odor free molding media having a polycarboxylic acid binder

(76) Inventors: Liang Chen, New Albany, OH (US); William E. Downey, Granville, OH (US); Kathleen M. Bullock, Zanesville, OH (US)

Correspondence Address: OWENS CORNING, 2790 COLUMBUS ROAD, GRANVILLE, OH, 43023, US

(21) Appl. No.: 10/185,145

(22) Filed: Jun. 27, 2002

(51) Int. Cl. C08K 3/34; C08K 3/40; C08K 11/00

(52) U.S. Cl. 524/494; 524/442

(57) ABSTRACT

A polycarboxylic acid based binder material used in fiberglass media products. The binder material eliminates the odor and emissions complaints associated with urea phenol formaldehyde based binder systems and has a significantly longer shelf life. The polycarboxylic acid based binder material has a loss of ignition value of between approximately 15 and 20 percent is applied in a one-step process. Preferably, the binder material comprises a polycarboxylic acid binder, and more preferably a polyacrylic acid binder. The polycarboxylic acid binder is crosslinked with either glycerol or triethanol amine. A silane-coupling agent is typically added at approximately 0.1 percent based on binder solids to improve adhesion of the binder to the fiberglass wool reinforcement.

### TECHNICAL FIELD

The present invention relates fiberglass molding media products and more specifically to a fiberglass molding media product having a polycarboxylic acid binder.

### BACKGROUND OF THE INVENTION

Fibrous acoustical insulation products, or fiberglass molding media products, are commonly used in various applications to prevent unwanted sound from escaping a noise-producing device, such as a motor, machine, or appliance. These products are also used in such devices as office partitions to prevent acoustical sound from traveling between offices. Fibrous thermal insulation products have also been used to block undesirable heat transfer from buildings, industrial equipment and appliances. Also, fibrous insulation material has been used in structural applications for such applications as duct board.

When manufacturing thermal and acoustical insulation products from fibrous materials, a typical component is an organic binder, usually a urea phenol formaldehyde binder, to bond the fibers together where they intersect each other.

The disadvantage of these urea phenol formaldehyde binders is the emission of formaldehyde, phenol and amine containing odorants not only during the manufacture of shaped boards and articles but also during later use. These emissions may produce environmental concerns to workers due to prolonged exposure and also produce undesirable odor in the workplace.

Another disadvantage of urea phenol formaldehyde resins is that these resins have a limited shelf life due to binder instability. This can lead to increased manufacturing costs in terms of frequent cleanup and increased production. Further, because of the decreased shelf life, urea phenol formaldehyde molding media products generally must be produced in a two step process in which a portion of the binder is applied to the fiberglass and cured to form an intermediate fiberglass blanket, known as basic wool, followed by a second application of binder that is dried to the blanket and shipped to the customer for final curing, a process that increases cycle time and hence manufacturing costs.

A further disadvantage of urea phenol formaldehyde binders is that they absorb moisture in the uncured blankets. This leads to increased cycle time and decreased productivity.

It is thus highly desirable to develop a low-odor fiberglass molding media product that is phenol and formaldehyde free. It is also highly desirable to increase the shelf life of the binder system used in fiberglass molding media products. It is also highly desirable to produce the media products in either a one step or two step process that meets customer demands.

### SUMMARY OF THE INVENTION

A polycarboxylic bound fiberglass molding media product is produced in the present invention. The media product eliminates the use of phenol formaldehyde based binders, thereby eliminating formaldehyde, phenol and amine containing odorant emissions concerns during the manufacturing process and in end use applications.

The polycarboxylic binder can be applied in a one step process, thereby decreasing manufacturing costs. The polycarboxylic binder also has a significantly longer shelf life than urea phenol formaldehyde binders, thereby decreasing manufacturing and cleanup costs. Further, because these binders do not absorb moisture in an uncured form, cycles times are decreased, thereby increasing productivity.

The foregoing and other advantages of the invention will become apparent from the following disclosure in which one or more preferred embodiments of the invention are described in detail and illustrated in the accompanying drawings. It is contemplated that variations in procedures, structural features and arrangement of parts may appear to a person skilled in the art without departing from the scope of or sacrificing any of the advantages of the invention.

### BRIEF DESCRIPTION OF DRAWINGS

FIG. 1 illustrates a one step process for making a fiberglass molding media product according to one preferred embodiment of the present invention.

### DETAILED DESCRIPTION AND PREFERRED EMBODIMENTS OF THE INVENTION

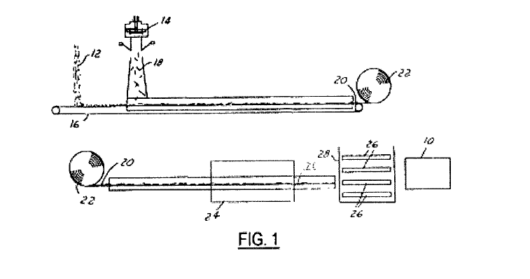

FIG. 1 describes a preferred one step process for making a fiberglass molding media product 10 according to the present invention.

Referring now to FIG. 1, a one-step process for making the media product 10 begins by introducing regular or slightly coarse fiberglass insulation wool 12 onto a conveyor belt 16 in a manner well known in the art. A binder material 18 is applied to the wool 12 from a curtain coater or similar application device 14. This forms an uncured or partially cured intermediate product 20. The intermediate product 20 is then rolled onto a creel 22 for later processing at, for example, a customer's manufacturing facility. While not shown, kraft paper is added as a facing material without adhesive to protect the intermediate product 20 during shipping.

To process further, at a customer's facility or otherwise, the intermediate product 20 is unrolled from the creel 22, the facing material removed, and the product 20 is cut to an appropriate shape in a fabricator 24 or similar device to form a shaped intermediate product 26. The shaped intermediate product 26 is then placed into a mold 28. The mold 28 is closed at a specified temperature and time to mold the shaped intermediate product 26 into the finished media product 10. The product 10 is then removed from the mold 28 for use.

The specific temperature and time that the intermediate product 26 is contained within the mold 28 is dependent upon numerous factors, including but not limited to the thickness of the finished product 10, the density of the glass wool 12, and the composition of the binder material 18. However, for finished products having a thickness between approximately 0.125 and 2 inches, a molding temperature of approximately 175-260 degrees Celsius (350-500 degrees Fahrenheit) for between approximately 0.5 and 5 minutes is sufficient to ensure adequate cure of the foamed binder material 18. The mold 28 is also kept at sufficient pressure to ensure that the finished product 10 is of appropriate thickness.

The binder material 18 used in the present invention is preferably a polycarboxylic acid based binder mixed with a small amount of a silane-coupling agent (0.1% based on binder solids) and water. The binder material 18 also contains a crosslinking agent such as glycerol or triethanol amine used to crosslink the polycarboxylic acid after application. The binder material 18 should have an LOI (“loss of ignition”) value of between 15 and 20%.

One preferred polycarboxylic acid resin that meets these criteria is a polyacrylic acid resin such as QRXP 1629S (“PAG Plus”), available from Rohm and Haas. PAG plus is a surfactant added low odor polyacrylic binder that uses glycerol as a crosslinking agent. To make the binder material 18, the PAG Plus is mixed with A-1100 silane-coupling agent (0.1% based on binder solids), available from OSI, and water to a desired viscosity and solids. This binder material 18 is preferably molded at approximately 205 degrees Celsius (approximately 400 degrees Fahrenheit) for about 2 minutes to form a 1-inch thick product 10.

Another binder that may be used is QRXP 1513, also available from Rohm and Haas. QRXP 1513 is a blend of polyacrylic acid and triethanol amine that utilizes sodium hypophosphite as a cure catalyst. To make the binder material 18, the QRXP 1513 is mixed with A-1100 silane-coupling agent (0.1% based on binder solids), available from OSI, and water to a desired viscosity and solids. This binder material 18 is preferably molded at approximately 205 degrees Celsius (approximately 400 degrees Fahrenheit) for about 2 minutes to form a 1-inch thick product 10. Of course, one disadvantage to this process, as compared to using PAG plus, is the potential for small amounts of amine odor emission due to the presence of triethanol amine. However the emissions were not reported in the trial below.

### EXAMPLES

Table 1 below illustrates binder characteristics and oven temperatures utilized for making a partially cured or uncured intermediate product 20 from preferred polycarboxylic binder materials as described above in FIG. 1. Also shown below is Table 2 which illustrates other processing conditions utilized to form the intermediate product 26 of Table 1:

TABLE 1

| Example | Binder | LO1% | Oven Temp | Others |
|---|---|---|---|---|
| 1 | PAG Plus | 15 | 398, 350 | Bridge 1.5 and 4″, dry |
| 2 | PAG Plus | 15 | 350, 294 | Bridge 4″ |
| | | | (burner off) | |
| 3 | PAG Plus | 15 | 285, 260 | Bridge 2″ |
| 4 | PAG Plus | 20 | 250, 245 | Bridge 2″ |
| 5 | QRXP 1513 | 15 | 250, 245 | Bridge 2″ |
| 6 | QRXP 1513 | 20 | 250, 245 | Bridge 2″ |

TABLE 2

| | |
|---|---|
| Fiberizer: | 2 units |
| Glass Pull: | 2000 lb/hr |
| Width: | 80 inch |
| Square ft weight: | 0.134 lb/ft2 |
| Line speed: | 35 ft/min |

The same six examples in Table 1 were then subsequently processed to form media products 10 according to the process as described in FIG. 1. This was accomplished using a hot plate molding device at a molding temperature of approximately 230 degrees Celsius (450 degrees) for either 1 or 1.2 minutes. The processing conditions were set similar to those used in urea phenol formaldehyde based media products of the prior art, wherein uncured urea phenol formaldehyde wool is molded at a mold temperature of 230 degrees Celsius for 1.6 minutes to yield an acceptable media product.

Table 3 below illustrates the curing percentage of the media products as produced utilizing the methods described above:

TABLE 3
Cure Percentage (%)

| Example | Binder | LO1% | Hot Plate Temp | 1 min | 1.2 min |
|---|---|---|---|---|---|
| 1 | PAG Plus | 15 | 450 F. | | |
| 2 | PAG Plus | 15 | 450 F. | 70 | 95 |
| 3 | PAG Plus | 15 | 450 F. | 80 | 95 |
| 4 | PAG Plus | 20 | 450 F. | | |
| 5 | QRXP 1513 | 15 | 450 F. | 85 | 95 |
| 6 | QRXP 1513 | 20 | 450 F. | 80 | 95 |

The molded media products 10 illustrated in Table 3 all displayed acceptable white appearances, satisfactory surface characteristics, and acceptable mechanical properties as compared to traditional urea phenol formaldehyde based products. Further, an acceptable cure was achieved in the six samples after only a minute. Importantly, no trimethyl amine, amine, ammonia, formaldehyde, phenol, or surfactant odor was detected during and after the curing process for forming the products 10.

A polycarboxylic bound fiberglass molding media product 10 as in FIG. 1 offers many advantage of urea phenol formadehyde based media products. The media product 10 eliminates the use of phenol formaldehyde based binders, thereby eliminating formaldehyde, phenol and amine containing odorant emissions concerns during the manufacturing process and in end use applications. Further, the polycarboxylic binder material 18 can be applied in a one step process, thereby decreasing manufacturing costs. The polycarboxylic binder material 18 also has a significantly longer shelf life than urea phenol formaldehyde binders, thereby decreasing manufacturing and cleanup costs. Finally, because these binder materials 18 do not absorb moisture in an uncured form, cycles times are decreased, thereby increasing productivity.

While the invention has been described in terms of preferred embodiments, it will be understood, of course, that the invention is not limited thereto since modifications may be made by those skilled in the art, particularly in light of the foregoing teachings.

What is claimed is:

1. A one-step process for forming a fiberglass molding media product comprising:
providing a quantity of a fiberglass wool;
introducing a quantity of polycarboxylic acid based binder material to said fiberglass wool to form an intermediate product;
cutting said intermediate product to a desired shape to form a shaped intermediate product;
introducing said shaped intermediate product to a mold;
molding said shaped intermediate product at a first temperature and a first time to form the fiberglass media product having a first thickness, wherein said first temperature and first time are sufficient to ensure an adequately cured fiberglass molding media product at said first thickness.

2. The method of claim 1, wherein said first temperature is between approximately 175 and 260 degrees Celsius.

3. The method of claim 2, wherein said first time is between approximately 0.5 and 5 minutes.

4. The method of claim 1, wherein said first thickness is between approximately 0.125 and 2 inches.

5. The method of claim 1, wherein introducing a quantity of polycarboxylic acid based binder material to said fiberglass wool to form an intermediate product comprises introducing a quantity of polycarboxylic acid based binder material to said fiberglass wool to form an intermediate product, said polycarboxylic acid based binder material having a loss of ignition value between approximately 15 and 20 percent.

6. The method of claim 5, wherein said polycarboxylic acid based binder material comprises a polycarboxylic acid resin.

7. The method of claim 6, wherein said polycarboxylic acid resin comprises a polyacrylic acid resin.

8. The method of claim 5, wherein said polycarboxylic acid based binder material further comprises a glycerol crosslinking agent.

9. The method of claim 5, wherein said polycarboxylic acid based binder material further comprises a triethanol amine crosslinking agent and sodium hypophosphite as a cure catalyst.

10. The method of claim 7, wherein said polyacrylic acid resin comprises QRXP 1629A polyacrylic acid resin, available from Rohm and Haas.

11. The method of claim 7, wherein said polyacrylic acid resin comprises QRXP 1513 polyacrylic acid resin, available from Rohm and Haas.

12. The method of claim 6, wherein said polycarboxylic acid based binder material further comprises a silane-coupling agent.

13. The method of claim 12, wherein said silane-coupling agent comprises approximately 0.1% of the binder solids of said polycarboxylic acid based binder material.

14. The method of claim 12, wherein said silane-coupling agent comprises A-1100, available from OSI.

15. A fiberglass media product comprising:
a quantity of a regular or slightly coarse fiberglass wool; and
a polycarboxylic acid based binder system cured to said quantity fiberglass wool.

16. The media product of claim 15, said polycarboxylic acid based binder material has a loss of ignition value between approximately 15 and 20 percent.

17. The media product of claim 16, wherein said polycarboxylic acid based binder material comprises a polyacrylic acid resin and a crosslinking agent.

18. The media product of claim 17, wherein said polyacrylic acid resin comprises QRXP 1629A polyacrylic acid resin, available from Rohm and Haas, and wherein said crosslinking agent comprises glycerol.

19. The media product of claim 17, wherein said polyacrylic acid comprises QRXP 1513 polyacrylic acid resin, available from Rohm and Haas, and wherein said crosslinking agent comprises a triethanol amine.

20. The media product of claim 17, wherein said polycarboxylic acid based binder material further comprises a silane-coupling agent, wherein said silane-coupling agent comprises about 0.1% of the binder solids of said polycarboxylic acid based binder material.
